(19) United States
(12) Patent Application Publication
(10) Pub. No.: US 2014/0037326 A1
(43) Pub. Date: Feb. 6, 2014

(54) Image Forming Apparatus and Process Unit Capable of Collecting Developer on Photosensitive Drum

(71) Applicant: Junichi Hashimoto, Toyohashi-shi (JP)

(72) Inventor: Junichi Hashimoto, Toyohashi-shi (JP)

(73) Assignee: BROTHER KOGYO KABUSHIKI KAISHA, Nagoya-shi (JP)

(21) Appl. No.: 13/953,818

(22) Filed: Jul. 30, 2013

(30) Foreign Application Priority Data
Jul. 31, 2012 (JP) 2012-169819

(51) Int. Cl. G03G 15/08; G03G 21/00

(52) U.S. Cl. CPC G03G 21/0058
USPC 399/103; 399/357; 399/284

(57) ABSTRACT

An image forming apparatus includes: a photosensitive drum; a developing roller; a supply roller; and a cleaning roller. The developing roller supplies developer to the photosensitive drum. The supply roller supplies developer to the developing roller and has a supply roller body. The cleaning roller collects developer on the photosensitive drum and has a cleaning roller body. Axial end faces of the cleaning roller body and axial end faces of the supply roller body are at the same position in the axial direction, or the axial end faces of the cleaning roller body is positioned outward of the axial end faces of the supply roller body in the axial direction. The cleaning roller rotates in one of a forward direction and a reverse direction at a contact portion where the cleaning roller contacts the photosensitive drum. The cleaning roller rotates at a peripheral speed slower than a peripheral speed of the photosensitive drum when rotating in the forward direction.

### CROSS REFERENCE TO RELATED APPLICATION

This application claims priority from Japanese Patent Application No. 2012-169819 filed Jul. 31, 2012. The entire content of the priority application is incorporated herein by reference.

### TECHNICAL FIELD

The present invention relates to an image forming apparatus provided with a cleaning roller capable of collecting developer on a photosensitive drum, and also relates to a process unit provided with a cleaning roller capable of collecting developer on a photosensitive drum.

### BACKGROUND

One electrophotographic image forming apparatus known in the art includes a cleaning roller adapted to clean a photosensitive drum while the cleaning roller contacts the photosensitive drum. The cleaning roller performs the cleaning operation for the photosensitive drum before an electrostatic latent image is formed on the photosensitive drum. For this reason, the cleaning roller is disposed on an upstream side of a charger, which is adapted to charge the photosensitive drum, in a rotation direction of the photosensitive drum, thereby collecting residual developer deposited on the photosensitive drum. The cleaning roller rotates in a forward direction the same as the rotation direction of the photosensitive drum at a position where the cleaning roller contacts the photosensitive drum and at a peripheral speed faster than a peripheral speed of the photosensitive drum.

Further, another image forming apparatus known in the art includes a layer thickness regulation blade adapted to reduce developer leakage from a gap between a developing roller and a pair of seal members with which axial end portions of the developing roller is in sliding contact, by changing the layer thickness of developer carried on the developing roller between a center portion of the developing roller and axial end portions of the developing roller.

In this type of image forming apparatus, the layer thickness regulation blade is formed with notches at positions corresponding to the axial end portions of the developing roller, thereby preventing developer carried on the axial end portions of the developing roller from separating therefrom. With the notches, a contact pressure applied to the axial end portions of the developing roller becomes greater than that applied to the center portion of the developing roller, thereby making the layer thickness of developer carried on the axial end portions of the developing roller thinner than that on the center portion of the developing roller.

### SUMMARY

However, in the latter image forming apparatus, the thinner layer of developer carried on the axial end portions of the developing roller is not sufficiently tribo-charged, and electric charge amount thereof becomes unstable. Such unstable developer can be easily deposited on the photosensitive drum. This may cause a so-called “fog”.

In case the image forming apparatus in which the fog may occur includes the above-described cleaning roller, developer deposited on the photosensitive drum due to the fog is likely to fly toward a charger disposed on a downstream side of the cleaning roller, which stains the charger. If the charger is stained by developer, discharge error may occur.

In view of the foregoing, it is an object of the present invention to provide an image forming apparatus and a process unit capable of sufficiently collecting developer on a photosensitive drum without staining a charger.

In order to attain the above and other objects, the present invention provides an image forming apparatus including: a photosensitive drum; a developing roller; a supply roller; and a cleaning roller. The photosensitive drum is configured to rotate in a rotation direction and has an axis extending in an axial direction. The developing roller extends in the axial direction and is configured to supply developer to the photosensitive drum. The supply roller is configured to rotate and to supply developer to the developing roller. The supply roller has a supply roller shaft extending in the axial direction and a supply roller body contacting the developing roller. The cleaning roller is configured to rotate and to collect developer on the photosensitive drum. The cleaning roller has a cleaning roller shaft extending in the axial direction and a cleaning roller body contacting the photosensitive drum at a contact portion. The cleaning roller body has end faces in the axial direction. The supply roller body has end faces in the axial direction. The end faces of the cleaning roller body and the end faces of the supply roller body are at the same position in the axial direction, or the end faces of the cleaning roller body is positioned outward of the end faces of the supply roller body in the axial direction. The cleaning roller is further configured to rotate in one of a forward direction the same as the rotation direction of the photosensitive drum at the contact portion and a reverse direction opposite to the rotation direction of the photosensitive drum at the contact portion. The cleaning roller is further configured to rotate at a peripheral speed slower than a peripheral speed of the photosensitive drum when rotating in the forward direction

According to another aspect, the present invention provides an image forming apparatus including: a photosensitive drum; a developing roller; a cleaning roller; and a layer thickness regulation blade. The photosensitive drum is configured to rotate in a rotation direction and has an axis extending in an axial direction. The developing roller extends in the axial direction and is configured to supply developer to the photosensitive drum. The cleaning roller is configured to rotate and to collect developer on the photosensitive drum. The cleaning roller has a cleaning roller shaft extending in the axial direction and a cleaning roller body contacting the photosensitive drum at a contact portion. The cleaning roller body has end faces in the axial direction. The layer thickness regulation blade is configured to regulate a layer thickness of developer carried on the developing roller. Each axial end portion of the layer thickness regulation blade has a notch being generally rectangular in shape. Each of the notches has an outer edge and an inner edge in the axial direction. The end faces of the cleaning roller body and the inner edges of the notches are at the same position in the axial direction, or the end faces of the cleaning roller body is positioned outward of the inner edges of the notches in the axial direction. The cleaning roller is further configured to rotate in one of a forward direction the same as the rotation direction of the photosensitive drum at the contact portion and a reverse direction opposite to the rotation direction of the photosensitive drum at the contact portion. The cleaning roller is further configured to rotate at a peripheral speed slower than a peripheral speed of the photosensitive drum when rotating in the forward direction.

According to still another aspect, the present invention provides a process unit including: a photosensitive drum; a developing roller; a supply roller; and a cleaning roller. The photosensitive drum is configured to rotate in a rotation direction and has an axis extending in an axial direction. The developing roller is configured to supply developer to the photosensitive drum. The supply roller is configured to supply developer to the developing roller. The supply roller has a supply roller shaft extending in the axial direction, and a supply roller body having a first length in the axial direction and contacting the developing roller. The cleaning roller is configured to collect developer on the photosensitive drum. The cleaning roller has a cleaning roller shaft extending in the axial direction, and a cleaning roller body having a second length in the axial direction and contacting the photosensitive drum at a contact portion. The second length of the cleaning roller body is greater than the first length of the supply roller body. The cleaning roller is further configured to rotate in one of a forward direction the same as the rotation direction of the photosensitive drum at the contact portion and a reverse direction opposite to the rotation direction of the photosensitive drum at the contact portion. The cleaning roller is further configured to rotate at a peripheral speed slower than a peripheral speed of the photosensitive drum when rotating in the forward direction.

According to still another aspect, the present invention provides a process unit including: a photosensitive drum; a developing roller; a layer thickness regulation blade; and a cleaning roller. The photosensitive drum is configured to rotate in a rotation direction and has an axis extending in an axial direction. The developing roller is configured to supply developer to the photosensitive drum. The layer thickness regulation blade is configured to regulate a layer thickness of developer carried on the developing roller and extends in the axial direction. Each axial end portion of the layer thickness regulation blade has a notch. Each notch has an inner edge in the axial direction. A seventh length is defined by a distance between the inner edges of the notches in the axial direction. The cleaning roller is configured to collect developer on the photosensitive drum. The cleaning roller has a cleaning roller shaft extending in the axial direction, and a cleaning roller body having an eighth length in the axial direction and contacting the photosensitive drum at a contact portion. The eighth length of the cleaning roller body is greater than the seventh length. The cleaning roller is further configured to rotate in one of a forward direction the same as the rotation direction of the photosensitive drum at the contact portion and a reverse direction opposite to the rotation direction of the photosensitive drum at the contact portion. The cleaning roller is further configured to rotate at a peripheral speed slower than a peripheral speed of the photosensitive drum when rotating in the forward direction.

### BRIEF DESCRIPTION OF THE DRAWINGS

In the drawings;

FIG. 1 is a schematic cross-sectional view of a color printer according to one embodiment of the present invention;

FIG. 2 is an enlarged partial cross-sectional view of the color printer, showing a structure of a process cartridge provided in the color printer;

FIG. 3 is a view of a layer thickness regulation blade provided in the color printer, in which only left and right end portions of the layer thickness regulation blade are shown and a center portion thereof is omitted;

FIG. 4 is a partial perspective view of a developing cartridge provided in the color printer, showing a structure of a left end portion of the developing cartridge;

FIG. 5 is an explanatory view illustrating the positional relationship between left and right end portions of the layer thickness regulation blade, left and right end portions of a developing roller, left and right end portions of a supply roller, left and right end portions of a photosensitive drum, left and right end portions of a cleaning roller, and left and right end portions of a first collecting roller;

FIGS. 6A and 6B are explanatory views illustrating states where toner on the photosensitive drum is collected by the cleaning roller, in which FIG. 6A shows a case where the peripheral speed of the cleaning roller is slower than the peripheral speed of the photosensitive drum, and FIG. 6B shows a case where the peripheral speed of the cleaning roller is faster than the peripheral speed of the photosensitive drum; and

FIG. 7 is an explanatory view illustrating a state where toner on a photosensitive drum is collected by a cleaning roller in a process cartridge according to a modification.

### DETAILED DESCRIPTION

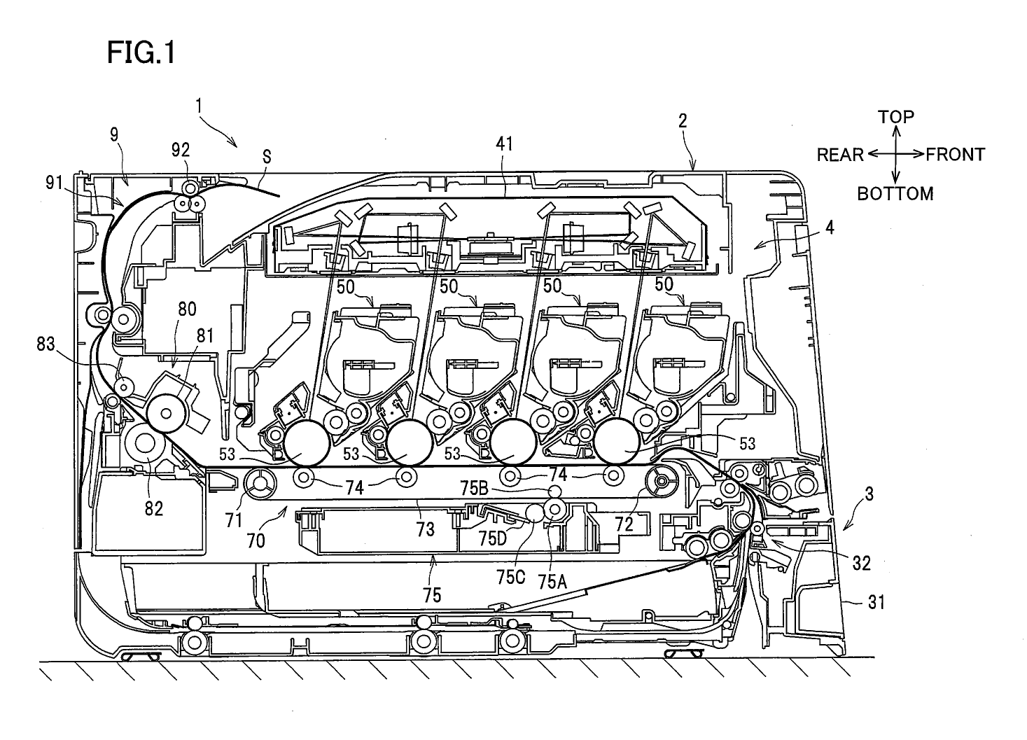

A color printer 1 as an image forming apparatus according to one embodiment of the present invention will be described with reference to FIGS. 1 through 6B.

Throughout the specification, the terms “upward”, “downward”, “upper”, “lower”, “above”, “below”, “beneath”, “right”, “left”, “front”, “rear” and the like will be used assuming that the color printer 1 is disposed in an orientation in which it is intended to be used. More specifically, in FIG. 1 a left side and a right side are a rear side and a front side, respectively. Further, in FIG. 1 a near side and a far side are a left side and a right side, respectively. Further, in FIG. 1 a top side and a bottom side are a top side and a bottom side, respectively.

<Overall Structure of Color Printer>

As shown in FIG. 1, the color printer 1 includes a main casing 2, and, within the main casing 2, also includes a sheet supply unit 3, an image formation unit 4, and a discharge unit 9.

The sheet supply unit 3 is disposed in a bottom portion of the main casing 2. The sheet supply unit 3 includes a sheet supply tray 31 that accommodates the sheets of paper S therein, and a sheet supply mechanism 32. The sheets S accommodated in the sheet supply tray 31 are supplied to the image formation unit 4 by the sheet supply mechanism 32.

The image formation unit 4 is adapted to form an image on each sheet S conveyed from the sheet supply unit 3. The image formation unit 4 includes an exposure unit 41, four process cartridges 50, a transfer unit 70 and a fixing unit 80.

The exposure unit 41 is disposed in a top portion of the main casing 2. The exposure unit 41 includes a laser light source (not shown), a polygon mirror (shown in FIG. 1 without a reference numeral), a plurality of lenses (shown in FIG. 1 without a reference numeral), and a plurality of reflection mirrors (shown in FIG. 1 without a reference numeral). A laser beam emitted from the laser light source based on image data is reflected by the polygon mirror and the reflecting mirrors, and passes through the lenses. A surface of each photosensitive drum 53 is subjected to high-speed scan of the laser beam.

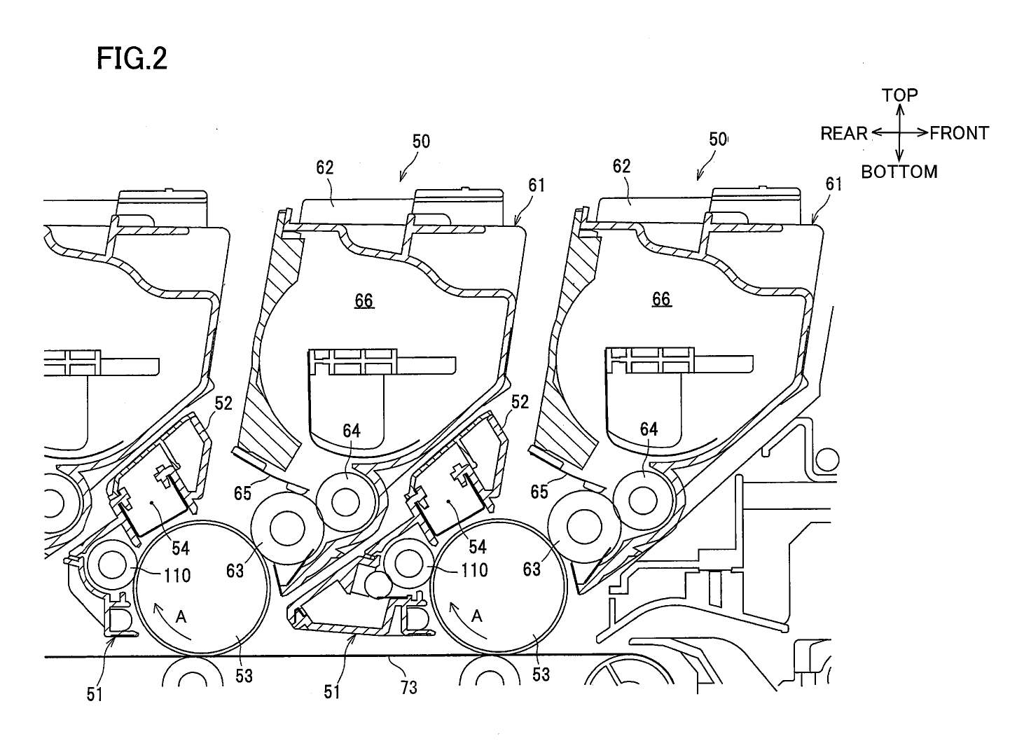

The four process cartridges 50 are disposed between the sheet supply tray 31 and the exposure unit 41 in a vertical direction, and also disposed juxtaposed with each other in a front-rear direction. As shown in FIG. 2, each process cartridge 50 includes a drum unit 51 and a developing cartridge 61. The developing cartridge 61 is detachable from and attachable to the drum unit 51.

As shown in FIG. 2, the drum unit 51 includes a drum frame 52, the photosensitive drum 53, a charger 54 and a cleaning roller 110. The photosensitive drum 53 is rotatably supported to the drum frame 52 and has an axis extending in an axial direction.

The charger 54 is adapted to charge the corresponding photosensitive drum 53. The charger 54 is disposed on a downstream side of a contact area where the photosensitive drum 53 contacts the cleaning roller 110 (described later) in a rotational direction A of the photosensitive drum 53. Note that, in this embodiment, the photosensitive drum 53 rotates in a clockwise direction in FIG. 2.

The cleaning roller 110 contacts the surface of the photosensitive drum 53 and is rotatably supported to the drum frame 52. A bias controlled by a known control device (not shown) is applied to the cleaning roller 110. The cleaning roller 110 is adapted to collect toner carried on the photosensitive drum 53 during an image forming operation and to expel the collected toner onto the photosensitive drum 53 at a predetermined timing when the image forming operation is not performed. Incidentally, the detailed structure of the cleaning roller 110 will be described later.

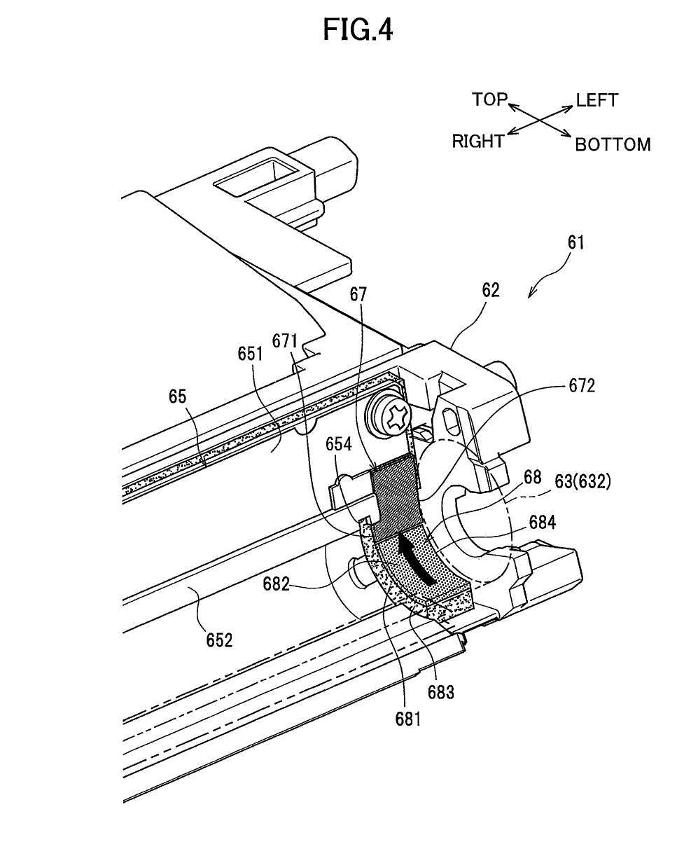

The developing cartridge 61 includes a developing frame 62, a developing roller 63, a supply roller 64, a layer thickness regulation blade 65, a pair of blade seal members 67 and a pair of side seal members 68 (see FIG. 4). Further, the developing cartridge 61 also includes a toner chamber 66 that accommodates toner therein. The developing roller 63 and the supply roller 64 are rotatably supported to the developing frame 62.

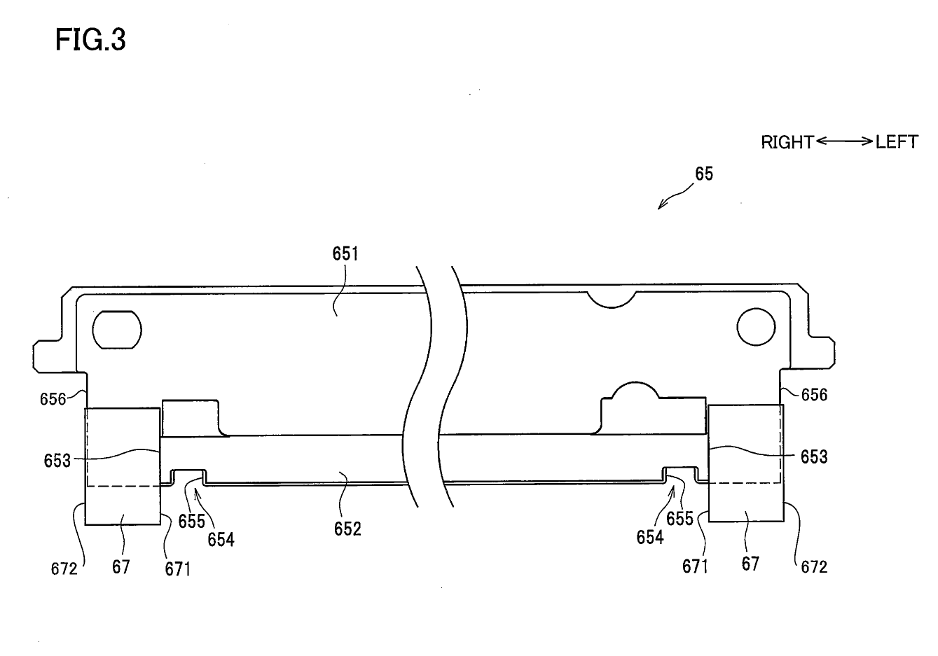

The layer thickness regulation blade 65 is adapted to regulate a layer thickness of toner carried on the developing roller 63 with a peripheral surface of the developing roller 63 being in sliding contact with the layer thickness regulation blade 65. As shown in FIG. 3, the layer thickness regulation blade 65 includes a blade body 651 and a pressing member 652.

The blade body 651 is formed of a metal plate, extending in the axial direction of the photosensitive drum 53. The blade body 651 has a base end portion fixed to the developing frame 62 and extends downward from the base end portion. The blade body 651 has a length sufficient to reach the developing roller 63 from the base end portion.

The pressing member 652 is formed of rubber, for example. The pressing member 652 is fixed to a tip end portion of the blade body 651. More specifically, the pressing member 652 is fixed to a surface of the blade body 651 facing the developing roller 63. The pressing member 652 protrudes from the blade body 651 toward the developing roller 63 and is so formed that the developing roller 63 is in sliding contact with the pressing member 652.

The layer thickness regulation blade 65 is formed with generally rectangular shaped notches 654, 654 at end portions thereof in the axial direction. In other words, one of the notches 654 is formed at the left end portion of the layer thickness regulation blade 65 and remaining one of the notches 654 is formed at the right end portion of the layer thickness regulation blade 65. More specifically, notches 654, 654 are formed in the blade body 651 and the pressing member 652 so as to be depressed from the tip end portions of the blade body 651 and the pressing member 652 toward the base end portions thereof.

As shown in FIG. 4, each blade seal member 67 is adhered to the blade body 651 at a position in proximity to and outside of an axial end portion of the pressing member 652. The blade seal member 67 is made of non-woven fabric. The blade seal member 67 is disposed so as to protrude outward of the tip end portion of the blade body 651. Peripheral surfaces of axial end portions of the developing roller 63 are in sliding contact with the blade seal members 67.

Each side seal member 68 is disposed between the developing frame 62 and the developing roller 63. The side seal member 68 includes a resilient base member 681 and a surface member 682. The surface member 682 is layered on a surface of the base member 681 facing the developing roller 63. The side seal member 68 extends continuously from a tip end of the blade seal member 67 (i.e. an upstream end thereof in a rotation direction of the developing roller 63) so as to conform to an outer peripheral shape of the developing roller 63. The peripheral surfaces of the axial end portions of the developing roller 63 are also in sliding contact with the side seal members 68.

Returning to FIG. 1, the transfer unit 70 is disposed between the sheet supply unit 3 and the four process cartridges 50 in the vertical direction. The transfer unit 70 includes a drive roller 71, a driven roller 72, a conveyor belt 73, transfer rollers 74, and a belt cleaner 75.

The drive roller 71 and the driven roller 72 are arranged parallel to each other and are spaced apart from each other in the front-rear direction. The conveyor belt 73 is formed of an endless belt and is looped around the drive roller 71 and the driven roller 72. Each of the four transfer rollers 74 is disposed inside the conveyor belt 73, and also disposed in confrontation with the corresponding photosensitive drum 53, with an upper portion of the conveyor belt 73 interposed therebetween. A transfer bias is applied to each transfer roller 74 by constant current control during a transfer operation.

The belt cleaner 75 is adapted to collect toner deposited on the conveyor belt 73. As shown in FIG. 1, the belt cleaner 75 is disposed below the conveyor belt 73. The belt cleaner 75 includes a first collecting roller 75A, a backup roller 75B, a second collecting roller 75C, a blade 75D, and a waste toner box (shown in FIG. 1 without a reference numeral).

The first collecting roller 75A has a portion contacting an outer surface of the conveyor belt 73, and rotates with a lower portion of the conveyor belt 73 interposed between the first collecting roller 75A and the backup roller 75B, thereby collecting toner on the conveyor belt 73. The second collecting roller 75C is adapted to rotate while contacting the first collecting roller 75A, and to attract the toner collected by the first collecting roller 75A. The blade 75D is disposed so that the second collecting roller 75C is in sliding contact with the blade 75D. The blade 75D is adapted to scrape off the toner attracted to the second collecting roller 75C into the waste toner box disposed below the blade 75D.

The fixing unit 80 is disposed rearward of the process cartridges 50. The fixing unit 80 includes a heat roller 81 and a pressure roller 82. The pressure roller 82 is disposed in confrontation with the heat roller 81 and applies pressure thereto. A conveyance roller 83 is provided on a downstream side of the heat roller 81 in a sheet conveying direction of the sheets S and adapted to convey the sheets S to the discharge unit 9.

In the image formation unit 4, the charger 54 applies a uniform charge to the surface of the corresponding photosensitive drum 53. Subsequently, the photosensitive drum 53 is exposed to a laser beam emitted from the exposure unit 41, and an electrostatic latent image is formed on the surface of the photosensitive drum 53 based on image data. Further, toner accommodated in the toner chamber 66 is supplied onto the corresponding developing roller 63 through the supply roller 64. The layer thickness regulation blade 65 regulates the thickness of toner supplied onto the developing roller 63, maintaining the toner carried on the developing roller 63 at a thin uniform thickness.

At this time, edges of the notches 654 of the layer thickness regulation blade 65 are in contact with the developing roller 63. A pressure force applied to the developing roller 63 from the pressing member 652 in areas where the edges of the notches 654 of the layer thickness regulation blade 65 are in contact with the developing roller 63 becomes greater than that applied in other areas. As a result, a thickness of toner carried on a portion of the developing roller 63 corresponding to each notch 654 becomes thinner than a thickness of toner carried on a portion of the developing roller 63 inward of the notches 654 in the axial direction.

The toner carried on the developing roller 63 is supplied to the electrostatic latent image formed on the photosensitive drum 53, and accordingly, the toner develops the electrostatic latent image on the photosensitive drum 53 into a visible toner image. Subsequently, while the sheet S supplied from the sheet supply unit 3 is conveyed between the photosensitive drums 53 and the conveyor belt 73 (the transfer rollers 74 to which the transfer bias is applied), the toner images carried on respective photosensitive drums 53 are sequentially transferred onto the sheet S in a superimposed manner.

While the sheet S onto which the toner images are transferred passes between the heat roller 81 and the pressure roller 82, the toner images are fixed onto the sheet S by heat. As a result, an image is formed on the sheet S. The sheet S on which the image is formed is conveyed to a conveyance path 91 of the discharge unit 9 by the conveyance roller 83, and then, discharged outside the main casing 2 by a discharge roller 92.

<Detailed Structure of Cleaning Roller>

In order to describe the length of the cleaning roller 110, the developing roller 63, the supply roller 64, the layer thickness regulation blade 65, the blade seal member 67, the side seal member 68, and the first collecting roller 75A will be described.

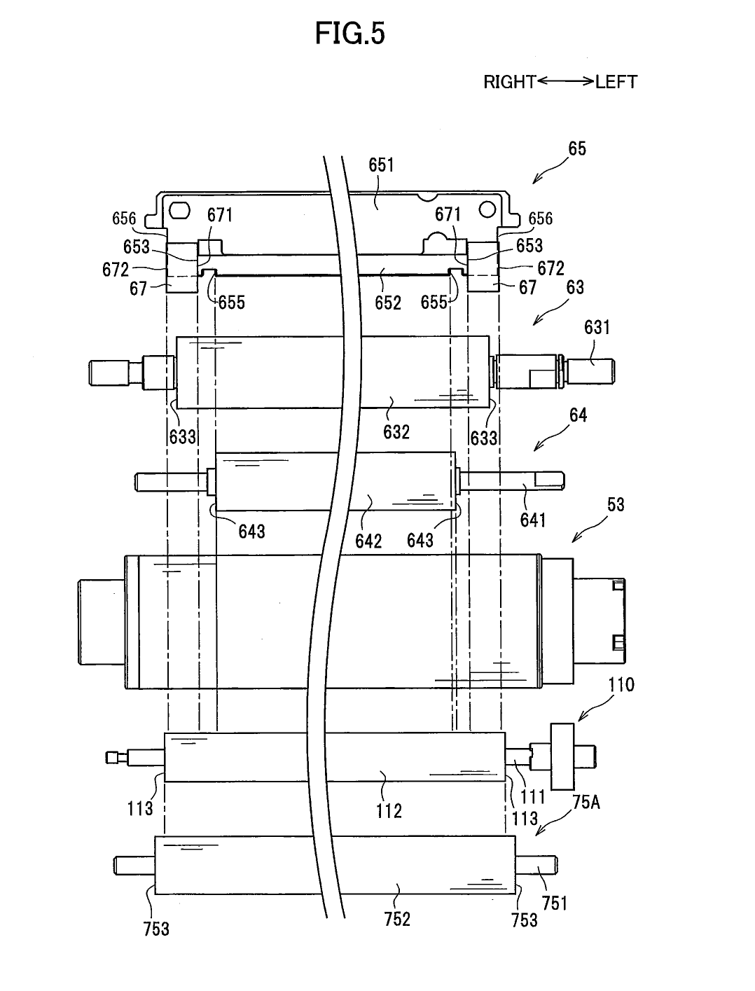

As shown in FIG. 5, the developing roller 63 has a developing roller shaft 631 and a developing roller body 632. The developing roller shaft 631 extends in the axial direction. The developing roller body 632 has an outer peripheral surface at a position coaxially with and radially outward of the developing roller shaft 631. Further, the developing roller body 632 has end faces 633, 633 at axial end portions thereof. The developing roller 63 is supported to the developing frame 62, and rotatable about an axis of the developing roller shaft 631 while the developing roller body 632 contacts the photosensitive drum 53.

The supply roller 64 has a supply roller shaft 641 and a supply roller body 642. The supply roller shaft 641 extends in the axial direction. The supply roller body 642 has an outer peripheral surface at a position coaxially with and radially outward of the supply roller shaft 641. Further, the supply roller body 642 has end faces 643, 643 at axial end portions thereof. The supply roller body 642 has a length in the axial direction smaller than that of the developing roller body 632. The end faces 643, 643 of the supply roller body 642 are positioned inward of the end faces 633, 633 of the developing roller body 632 in the axial direction. More specifically, the right end face 643 of the supply roller body 642 is positioned leftward of the right end face 633 of the developing roller body 632, and the left end face 643 of the supply roller body 642 is positioned rightward of the left end face 633 of the developing roller body 632.

The supply roller 64 is supported to the developing frame 62, and rotatable about an axis of the supply roller shaft 641 while the supply roller body 642 contacts the developing roller 63 (more specifically, the developing roller body 632).

The blade body 651 of the layer thickness regulation blade 65 has end faces 656, 656 in the axial direction and has a length in the axial direction (i.e. a length between the end faces 656, 656) substantially equal to that of the developing roller body 632. Further, the pressing member 652 has end faces 653, 653 at axial end portions thereof. The pressing member 652 has a length in the axial direction (i.e. a length between the end faces 653, 653) smaller than that of the blade body 651. The end faces 653, 653 of the pressing member 652 are positioned inward of the end faces 633, 633 of the developing roller body 632 in the axial direction and outward of the end faces 643, 643 of the supply roller body 642 in the axial direction. In other words, the length of the pressing member 652 in the axial direction is greater than the length of the supply roller body 642 in the axial direction.

More specifically, the right end face 653 of the pressing member 652 is positioned leftward of the right end face 633 of the developing roller body 632 and rightward of the right end face 643 of the supply roller body 642, and the left end face 653 of the pressing member 652 is positioned rightward of the left end face 633 of the developing roller body 632 and leftward of the left end face 643 of the supply roller body 642. In other words, the right end face 653 of the pressing member 652 is positioned between the right end face 633 of the developing roller body 632 and the right end face 643 of the supply roller body 642 in a left-right direction, and the left end face 653 of the pressing member 652 is positioned between the left end face 633 of the developing roller body 632 and the left end face 643 of the supply roller body 642 in the left-right direction.

Each notch 654 formed in the layer thickness regulation blade 65 has an inner edge 655 in the axial direction. The inner edges 655, 655 of the notches 654, 654 are positioned inward of the end faces 633, 633 of the developing roller body 632 in the axial direction. More specifically, the inner edge 655 of the right notch 654 of the layer thickness regulation blade 65 is positioned leftward of the right end face 633 of the developing roller body 632, and the inner edge 655 of the left notch 654 of the layer thickness regulation blade 65 is positioned rightward of the left end face 633 of the developing roller body 632.

Each blade seal member 67 has a width in the axial direction extending from the end face 653 of the pressing member 652 to the end face 656 of the blade body 651. Each blade seal member 67 has an inner end 671 and an outer end 672 in the axial direction. Further, as shown in FIG. 4, each side seal member 68 has an inner end 683 and an outer end 684 in the axial direction. Each side seal member 68 has a width in the axial direction substantially equal to that of each blade seal member 67. The inner end 671 is substantially at the same position as the inner end 683 in the axial direction, and the outer end 672 is substantially at the same position as the outer end 684 in the axial direction.

Returning to FIG. 5, the first collecting roller 75A has a first collecting roller shaft 751 and a first collecting roller body 752. The first collecting roller shaft 751 extends in the axial direction. The first collecting roller body 752 has an outer peripheral surface at a position coaxially with and radially outward of the first collecting roller shaft 751. Further, the first collecting roller body 752 has end faces 753, 753 at axial end portions thereof. The first collecting roller 75A is supported to the main casing 2, and rotatable about an axis of the first collecting roller shaft 751 while the first collecting roller body 752 contacts the conveyor belt 73.

The cleaning roller 110 has a cleaning roller shaft 111 and a cleaning roller body 112. The cleaning roller shaft 111 extends in the axial direction. The cleaning roller body 112 has an outer peripheral surface at a position coaxially with and radially outward of the cleaning roller shaft 111. Further, the cleaning roller body 112 has end faces 113, 113 at axial end portions thereof

The cleaning roller body 112 has a length in the axial direction greater than that of the supply roller body 642. The end faces 113, 113 of the cleaning roller body 112 are positioned outward of the end faces 643, 643 of the supply roller body 642 in the axial direction. More specifically, the right end face 113 of the cleaning roller body 112 is positioned rightward of the right end face 643 of the supply roller body 642, and the left end face 113 of the cleaning roller body 112 is positioned leftward of the left end face 643 of the supply roller body 642.

Further, the end faces 113, 113 of the cleaning roller body 112 are positioned outward of the outer ends 672, 672 of the blade seal members 67, 67 in the axial direction, and also outward of the outer ends 684, 684 of the side seal members 68, 68 in the axial direction. That is, the distance between the outer ends 672, 672 of the blade seal members 67, 67 in the axial direction is smaller than the length of the cleaning roller body 112 in the axial direction, and also the distance between the outer ends 684, 684 of the side seal members 68, 68 in the axial direction is smaller than the length of the cleaning roller body 112. More specifically, the right end face 113 of the cleaning roller body 112 is positioned rightward of the outer end 672 of the right blade seal member 67 and also positioned rightward of the outer end 684 of the right side seal member 68, and the left end face 113 of the cleaning roller body 112 is positioned leftward of the outer end 672 of the left blade seal member 67 and also positioned leftward of the outer end 684 of the left side seal member 68.

In other words, the end faces 113, 113 of the cleaning roller body 112 are positioned outward of the inner ends 671, 671 of the blade seal members 67, 67 in the axial direction, and also outward of the inner ends 683, 683 of the side seal members 68, 68 in the axial direction. That is, the distance between the inner ends 671, 671 of the blade seal members 67, 67 in the axial direction is smaller than the length of the cleaning roller body 112 in the axial direction, and also the distance between the inner ends 683, 683 of the side seal members 68, 68 in the axial direction is smaller than the length of the cleaning roller body 112. More specifically, the right end face 113 of the cleaning roller body 112 is positioned rightward of the inner end 671 of the right blade seal member 67 and also positioned rightward of the inner end 683 of the right side seal member 68, and the left end face 113 of the cleaning roller body 112 is positioned leftward of the inner end 671 of the left blade seal member 67 and also positioned leftward of the inner end 683 of the left side seal member 68.

Further, the end faces 113, 113 of the cleaning roller body 112 are positioned outward of the end faces 653, 653 of the pressing member 652 in the axial direction. More specifically, the right end face 113 of the cleaning roller body 112 is positioned rightward of the end face 653 of the pressing member 652, and the left end face 113 of the cleaning roller body 112 is positioned leftward of the end face 653 of the pressing member 652. In other words, the length of the cleaning roller body 112 in the axial direction is greater than the length of the pressing member 652 in the axial direction.

Further, the end faces 113, 113 of the cleaning roller body 112 are positioned outward of the inner edges 655, 655 of the notches 654, 654 in the axial direction. More specifically, the right end face 113 is positioned rightward of the inner edge 655 of the right notch 654 of the layer thickness regulation blade 65, and the left end face 113 is positioned leftward of the inner edge 655 of the left notch 654 of the layer thickness regulation blade 65. In other words, the length of the cleaning roller body 12 in the axial direction is greater than the distance between the inner edges 655, 655 of the notches 654, 654 in the axial direction.

The cleaning roller body 112 has a length in the axial direction smaller than that of the first collecting roller body 752 of the first collecting roller 75A. That is, the length in the axial direction of the portion of the first collecting roller 75A contacting the conveying belt 73 is greater than the length of the cleaning roller body 112 in the axial direction. The end faces 113, 113 of the cleaning roller body 112 are positioned inward of the end faces 753, 753 of the first collecting roller body 752 in the axial direction. More specifically, the right end face 113 of the cleaning roller body 112 is positioned leftward of the right end face 753 of the first collecting roller body 752, and the left end face 113 of the cleaning roller body 112 is positioned rightward of the left end face 753 of the first collecting roller body 752.

The cleaning roller 110 with the above-described structure is supported to the drum frame 52, and rotatable about an axis of the cleaning roller shaft 111 with the cleaning roller body 112 contacting the photosensitive drum 53.

The cleaning roller 110 rotates in a forward direction the same as the rotation direction A of the photosensitive drum 53 at the contact area where the cleaning roller 110 contacts the photosensitive drum 53 and also rotates at a peripheral speed slower than a peripheral speed of the photosensitive drum 53. That is, the cleaning roller 110 rotates in a direction opposite to the rotation direction A of the photosensitive drum 53.

Next, operations and effects of the color printer 1 according to the above-described embodiment will be described.

The cleaning roller 110 collects the toner deposited on the photosensitive drum 53 during the image forming operation while rotating and contacting the photosensitive drum 53.

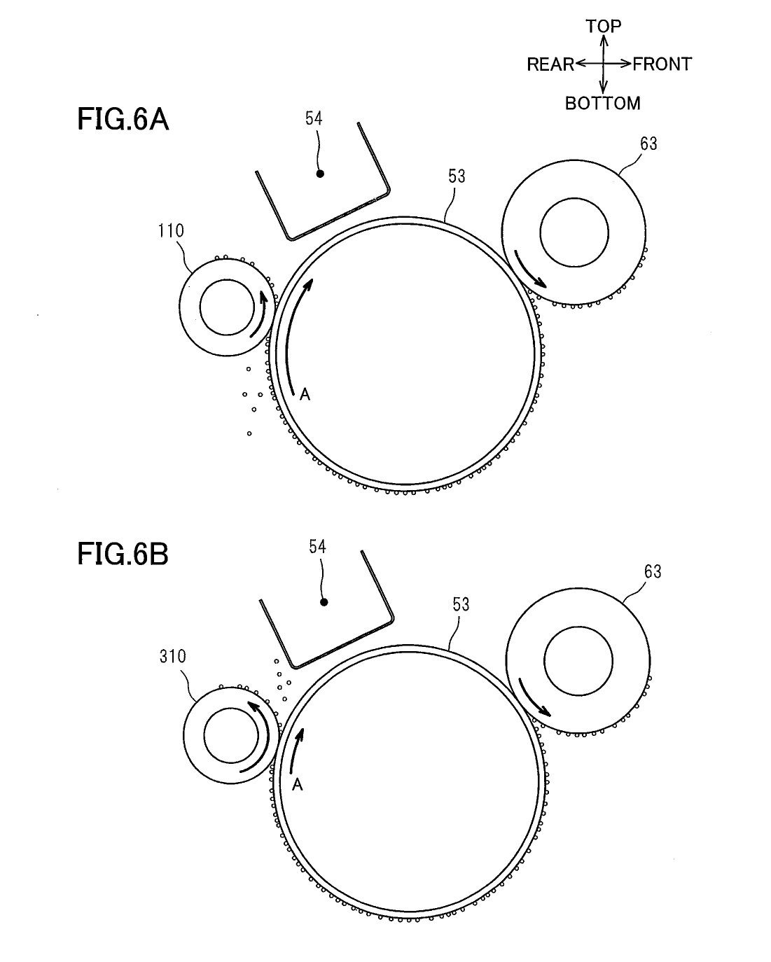

At this time, for example, assuming that, as shown in FIG. 6B, a cleaning roller 310 rotates in a forward direction the same as the rotation direction A of the photosensitive drum 53 at a contact area where the cleaning roller 310 contacts the photosensitive drum 53 and also rotates at a peripheral speed faster than the peripheral speed of the photosensitive drum 53, a force oriented in the forward direction the same as the rotation direction A of the photosensitive drum 53 is applied to the outer peripheral surface of the photosensitive drum 53 by the cleaning roller 310. In this case, if toner whose electric charge amount is unstable is carried on the photosensitive drum 53, the toner is likely to fly in the rotation direction A of the photosensitive drum 53. As a result, the charger 54 may be stained with the toner.

On the other hand, according to the above-described embodiment, as shown in FIG. 6A, a force oriented in a reverse direction opposite to the rotation direction A of the photosensitive drum 53 is applied to the outer peripheral surface of the photosensitive drum 53 by the cleaning roller 110. Hence, even if toner whose electric charge amount is unstable is carried on the photosensitive drum 53, the toner is likely to fly in the reverse direction opposite to the rotation direction A of the photosensitive drum 53. As a result, the toner carried on the photosensitive drum 53 is scraped off on an opposite side of the charger 54 with respect to the cleaning roller 110, thereby reducing the possibility of staining the charger 54 with toner.

Further, axial end portions of the cleaning roller body 112 extend outward of the supply roller body 642 in the axial direction. Hence, the cleaning roller body 112 contacts not only a portion of the outer peripheral surface of the photosensitive drum 53 where toner is supplied to the maximum but also portions of the outer peripheral surface of the photosensitive drum 53 outside the portion in the axial direction. As a result, the cleaning roller 110 can sufficiently collect toner on the photosensitive drum 53 even at the axial end portions of the photosensitive drum 53.

In the case of the above-described embodiment, one possible cause for carrying of unstable toner on the photosensitive drum 53 is that the layer thickness regulation blade 65 is formed with the notches 654 at the axial end portions thereof. As described above, because the layer thickness regulation blade 65 is formed with the notches 654 at the axial end portions thereof, the layer thickness of toner carried on the axial end portions of the developing roller body 632 corresponding to the notches 654 is thinner than the layer thickness of toner carried on the center portion of the developing roller body 632. As such, the difference of the layer thickness of toner is likely to cause electric charge amount of toner on the thinner portion to be unstable. As a result, unstable toner is carried on the photosensitive drum 53.

According to the above-described embodiment, the end faces 113, 113 of the cleaning roller body 112 of the cleaning roller 110 are positioned outward of the inner edges 655, 655 of the notches 654, 654. Even if unstable toner is carried on the axial end portions of the developing roller 63 due to the notches 654, 654 and is supplied onto the photosensitive drum 53, the toner can be collected by the cleaning roller 110.

Another possible cause for carrying of unstable toner on the photosensitive drum 53 is that toner may stay in the vicinity of the end faces 653, 653 of the pressing member 652 of the layer thickness regulation blade 65. Even if unstable toner remains in the vicinity of the axial end portions of the pressing member 652 and is deposited on the photosensitive drum 53, the end faces 113, 113 of the cleaning roller body 112 of the cleaning roller 110 are positioned outward of the end faces 653, 653 of the pressing member 652 in the axial direction. Hence, unstable toner on the photosensitive drum 53 can be collected by the cleaning roller 110.

Still another possible cause for carrying of unstable toner on the photosensitive drum 53 is that toner may stay at the ends of the blade seal members 67 and the side seal members 68. Even if unstable toner remains at the inner ends 671, 671 of the blade seal members 67, 67 and the inner ends 683, 683 of the side seal members 68, 68 and is deposited on the photosensitive drum 53, the end faces 113, 113 of the cleaning roller body 112 of the cleaning roller 110 are positioned outward of the inner ends 671, 671 of the blade seal members 67, 67 and the inner ends 683, 683 of the side seal members 68, 68 in the axial direction. Hence, unstable toner on the photosensitive drum 53 can be collected by the cleaning roller 110.

Further, the cleaning roller 110 expels the collected toner onto the photosensitive drum 53 at a predetermined timing when the image forming operation is not performed. The toner expelled onto the photosensitive drum 53 is conveyed onto the conveyor belt 73. Subsequently, the toner deposited on the conveyor belt 73 is collected by the first collecting roller 75A of the belt cleaner 75.

The end faces 753, 753 of the first collecting roller body 752 of the first collecting roller 75A are positioned outward of the end faces 113, 113 of the cleaning roller body 112 of the cleaning roller 110 in the axial direction. Hence, the first collecting roller 75A can clean the entire region of the conveyor belt 73 on which the toner expelled from the cleaning roller 110 is deposited.

Various modifications are conceivable.

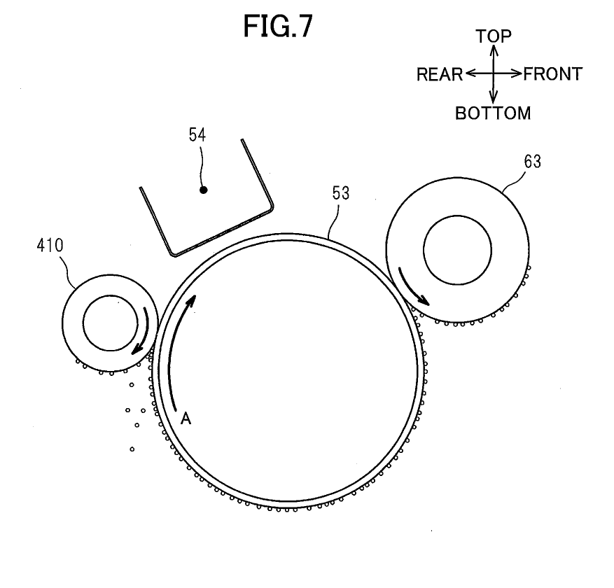

According to the above-described embodiment, the cleaning roller 110 is configured to rotate in the forward direction the same as the rotation direction A of the photosensitive drum 53 at the contact area where the cleaning roller 110 contacts the photosensitive drum 53. That is, the cleaning roller 110 is configured to rotate in the direction opposite to the rotation direction A of the photosensitive drum 53. However, as shown in FIG. 7, a cleaning roller 410 may be configured to rotate in a reverse direction opposite to the rotation direction A of the photosensitive drum 53 at a contact area where the cleaning roller 410 contacts the photosensitive drum 53. That is, the cleaning roller 410 is configured to rotate in a direction the same as the rotation direction A of the photosensitive drum 53. Incidentally, in this case, the cleaning roller 410 can rotate at any peripheral speed.

Even in this case, a force oriented in the reverse direction opposite to the rotation direction A of the photosensitive drum 53 is applied to the outer peripheral surface of the photosensitive drum 53 by the cleaning roller 410. Hence, even if toner whose electric charge amount is unstable is carried on the photosensitive drum 53, the toner is likely to fly in the reverse direction opposite to the rotation direction A of the photosensitive drum 53. As a result, staining the charger 54 with toner can be minimized.

According to the above-described embodiment, the end faces 113, 113 of the cleaning roller body 112 are positioned outward of the end faces 643, 643 of the supply roller body 642 in the axial direction. However, the end faces 113, 113 may be at the same position of the end faces 643, 643 of the supply roller body 642 in the axial direction.

Further, the end faces 113, 113 of the cleaning roller body 112 are positioned outward of the inner edges 655, 655 of the notches 654, 654 of the layer thickness regulation blade 65 in the axial direction. However, the end faces 113, 113 of the cleaning roller body 112 may be at the same position of the inner edges 655, 655 of the notches 654, 654 of the layer thickness regulation blade 65 in the axial direction.

According to the above-described embodiment, each notch 654 is rectangular in shape. However, the notch 654 may be formed in any shape as far as the shape is substantially rectangular. For example, the notch 654 may be formed in a trapezoidal shape.

According to the above-described embodiment, the first collecting roller 75A is illustrated as one example of a collecting member. However, for example, the collecting member may be a blade having an edge in contact with the outer surface of the conveyor belt 73 and adapted to scrape off toner on the outer surface of the conveyor belt 73 therefrom.

According to the above-described embodiment, the conveyor belt 73 for conveying the sheets S is illustrated as one example of a belt. However, the belt may be an intermediate transfer belt onto which a toner image is temporarily transferred from the photosensitive drums 53.

According to the above-described embodiment, the color printer 1 is illustrated as one example of an image forming apparatus. However, the present invention may be available for a monochromatic laser printer. In such a case, the monochromatic laser printer may not include the conveyor belt or the belt cleaner, and toner expelled from the cleaning roller to the photosensitive drum may be collected by the developing roller. In this case, it is desirable that the developing roller has axial end faces positioned outward of those of the cleaning roller in the axial direction.

While the present invention has been described in detail with reference to the embodiment thereof, it would be apparent to those skilled in the art that various changes and modifications may be made therein without departing from the spirit of the present invention.

What is claimed is:

1. An image forming apparatus comprising:
a photosensitive drum configured to rotate in a rotation direction and having an axis extending in an axial direction;
a developing roller extending in the axial direction and configured to supply developer to the photosensitive drum;
a supply roller configured to rotate and to supply developer to the developing roller, the supply roller having a supply roller shaft extending in the axial direction and a supply roller body contacting the developing roller; and
a cleaning roller configured to rotate and to collect developer on the photosensitive drum, the cleaning roller having a cleaning roller shaft extending in the axial direction and a cleaning roller body contacting the photosensitive drum at a contact portion,
wherein the cleaning roller body has end faces in the axial direction, the supply roller body having end faces in the axial direction, the end faces of the cleaning roller body and the end faces of the supply roller body being at the same position in the axial direction, or the end faces of the cleaning roller body being positioned outward of the end faces of the supply roller body in the axial direction,
wherein the cleaning roller is further configured to rotate in one of a forward direction the same as the rotation direction of the photosensitive drum at the contact portion and a reverse direction opposite to the rotation direction of the photosensitive drum at the contact portion, the cleaning roller being further configured to rotate at a peripheral speed slower than a peripheral speed of the photosensitive drum when rotating in the forward direction.

2. The image forming apparatus as claimed in claim 1, further comprising a layer thickness regulation blade configured to regulate a layer thickness of developer carried on the developing roller, the layer thickness regulation blade having a blade body, and a contact member protruding from the blade body to contact the developing roller, the contact member having end faces in the axial direction,
wherein the end faces of the contact member are positioned outward of the end faces of the supply roller body in the axial direction,
wherein the end faces of the cleaning roller body are positioned outward of the end faces of the contact member in the axial direction.

3. The image forming apparatus as claimed in claim 1, further comprising a pair of seal members positioned outward of the end faces of the supply roller body in the axial direction, the developing roller being in sliding contact with the pair of seal members,
wherein each of the seal members has an inner end in the axial direction,
wherein the end faces of the cleaning roller body are positioned outward of the inner ends of the seal members in the axial direction.

4. The image forming apparatus as claimed in claim 3, wherein each of the seal members has an outer end in the axial direction,
wherein the end faces of the cleaning roller body are positioned outward of the outer ends of the seal members in the axial direction.

5. The image forming apparatus as claimed in claim 1, wherein the cleaning roller is configured to expel developer collected from the photosensitive drum onto the photosensitive drum,
and the image forming apparatus further comprising:
a belt disposed in confrontation with the photosensitive drum, the developer expelled onto the photosensitive drum being conveyed onto the belt; and
a collecting member configured to collect developer deposited on the belt,
wherein the collecting member has end faces in the axial direction, the end faces of the collecting member being positioned outward of the end faces of the cleaning roller in the axial direction.

6. An image forming apparatus comprising:
a photosensitive drum configured to rotate in a rotation direction and having an axis extending in an axial direction;
a developing roller extending in the axial direction and configured to supply developer to the photosensitive drum;
a cleaning roller configured to rotate and to collect developer on the photosensitive drum, the cleaning roller having a cleaning roller shaft extending in the axial direction and a cleaning roller body contacting the photosensitive drum at a contact portion, the cleaning roller body having end faces in the axial direction; and
a layer thickness regulation blade configured to regulate a layer thickness of developer carried on the developing roller, each axial end portion of the layer thickness regulation blade having a notch being generally rectangular in shape, each of the notches having an outer edge and an inner edge in the axial direction, the end faces of the cleaning roller body and the inner edges of the notches being at the same position in the axial direction, or the end faces of the cleaning roller body being positioned outward of the inner edges of the notches in the axial direction,
wherein the cleaning roller is further configured to rotate in one of a forward direction the same as the rotation direction of the photosensitive drum at the contact portion and a reverse direction opposite to the rotation direction of the photosensitive drum at the contact portion, the cleaning roller being further configured to rotate at a peripheral speed slower than a peripheral speed of the photosensitive drum when rotating in the forward direction.

7. The image forming apparatus as claimed in claim 6, wherein the cleaning roller is configured to expel developer collected from the photosensitive drum onto the photosensitive drum,
and the image forming apparatus further comprising:
a belt disposed in confrontation with the photosensitive drum, the developer expelled onto the photosensitive drum being conveyed onto the belt; and
a collecting member configured to collect developer deposited on the belt,
wherein the collecting member has end faces in the axial direction, the end faces of the collecting member being positioned outward of the end faces of the cleaning roller in the axial direction.

8. The image forming apparatus as claimed in claim 6, wherein the layer thickness of developer carried on portions of the developing roller provided at positions corresponding to the notches being thinner than the layer thickness of developer carried on a portion of the developing roller provided at a position inward of the positions corresponding to the notches in the axial direction.

9. A process unit comprising:
a photosensitive drum configured to rotate in a rotation direction and having an axis extending in an axial direction;
a developing roller configured to supply developer to the photosensitive drum;
a supply roller configured to supply developer to the developing roller, the supply roller having a supply roller shaft extending in the axial direction, and a supply roller body having a first length in the axial direction and contacting the developing roller; and
a cleaning roller configured to collect developer on the photosensitive drum, the cleaning roller having a cleaning roller shaft extending in the axial direction, and a cleaning roller body having a second length in the axial direction and contacting the photosensitive drum at a contact portion, the second length of the cleaning roller body being greater than the first length of the supply roller body,
wherein the cleaning roller is further configured to rotate in one of a forward direction the same as the rotation direction of the photosensitive drum at the contact portion and a reverse direction opposite to the rotation direction of the photosensitive drum at the contact portion, the cleaning roller being further configured to rotate at a peripheral speed slower than a peripheral speed of the photosensitive drum when rotating in the forward direction.

10. The process unit as claimed in claim 9, further comprising a layer thickness regulation blade configured to regulate a layer thickness of developer carried on the developing roller, the layer thickness regulation blade having a blade body, and a contact member protruding from the blade body to contact the developing roller, the contact member having a third length in the axial direction greater than the first length of the supply roller body,
wherein the second length of the cleaning roller body is greater than the third length of the contact member.

11. The process unit as claimed in claim 9, further comprising a pair of seal members, each axial end portion of the developing roller being in sliding contact with each of the seal members,
wherein each of the seal members has an inner end in the axial direction, a fourth length being defined by a distance between the inner ends of the seal members in the axial direction, the fourth length being smaller than the second length of the cleaning roller body.

12. The process unit as claimed in claim 9, further comprising a pair of seal members, each axial end portion of the developing roller being in sliding contact with each of the seal members,
wherein each of the seal members has an outer end in the axial direction, a fifth length being defined by a distance between the outer ends of the seal members in the axial direction, the fifth length being smaller than the second length of the cleaning roller body.

13. An image forming apparatus comprising:
the process unit as claimed in claim 9, the cleaning roller being further configured to expel developer collected from the photosensitive drum onto the photosensitive drum;
a belt disposed in confrontation with the photosensitive drum, the developer expelled onto the photosensitive drum being conveyed onto the belt; and
a collecting member configured to collect developer deposited on the belt, the collecting member having a portion contacting the belt, the portion of the collecting member having a sixth length in the axial direction greater than the second length of the cleaning roller body.

14. A process unit comprising:
a photosensitive drum configured to rotate in a rotation direction and having an axis extending in an axial direction;
a developing roller configured to supply developer to the photosensitive drum;
a layer thickness regulation blade configured to regulate a layer thickness of developer carried on the developing roller and extending in the axial direction, each axial end portion of the layer thickness regulation blade having a notch, each notch having an inner edge in the axial direction, a seventh length being defined by a distance between the inner edges of the notches in the axial direction; and
a cleaning roller configured to collect developer on the photosensitive drum, the cleaning roller having a cleaning roller shaft extending in the axial direction, and a cleaning roller body having an eighth length in the axial direction and contacting the photosensitive drum at a contact portion, the eighth length of the cleaning roller body being greater than the seventh length,
wherein the cleaning roller is further configured to rotate in one of a forward direction the same as the rotation direction of the photosensitive drum at the contact portion and a reverse direction opposite to the rotation direction of the photosensitive drum at the contact portion, the cleaning roller being further configured to rotate at a peripheral speed slower than a peripheral speed of the photosensitive drum when rotating in the forward direction.

15. The process unit as claimed in claim 14, further comprising a pair of seal members, each axial end portion of the developing roller being in sliding contact with each of the seal members,
wherein each of the seal members has an inner end in the axial direction, a ninth length being defined by a distance between the inner ends of the seal members in the axial direction, the ninth length being smaller than the eighth length of the cleaning roller body.

16. The process unit as claimed in claim 14, further comprising a pair of seal members, each axial end portion of the developing roller being in sliding contact with each of the seal members,
wherein each of the seal members has an outer end in the axial direction, a tenth length being defined by a distance between the outer ends of the seal members in the axial direction, the tenth length being smaller than the eighth length of the cleaning roller body.

17. An image forming apparatus comprising:
the process unit as claimed in claim 14, the cleaning roller being further configured to expel developer collected from the photosensitive drum onto the photosensitive drum;
a belt disposed in confrontation with the photosensitive drum, the developer expelled onto the photosensitive drum being conveyed onto the belt; and
a collecting member configured to collect developer deposited on the belt, the collecting member having a portion contacting the belt, the portion of the collecting member having a eleventh length in the axial direction greater than the eighth length of the cleaning roller body.
